(19) United States
(12) Patent Application Publication
(10) Pub. No.: US 2014/0203932 A1
(43) Pub. Date: Jul. 24, 2014

(54) Electronic self-protection and emergency beacon device for wilderness use

(71) Applicants: Cecil W. Turner, Jamestown, SC (US); Pamela J. Turner, Jamestown, SC (US)

(72) Inventors: Cecil W. Turner, Jamestown, SC (US); Pamela J. Turner, Jamestown, SC (US)

(21) Appl. No.: 14/160,767

(22) Filed: Jan. 22, 2014

Related U.S. Application Data
(60) Provisional application No. 61/755,032, filed on Jan. 22, 2013.

(51) Int. Cl. G08B 25/01

(52) U.S. Cl. CPC G08B 25/016
USPC 340/539.13

(57) ABSTRACT

A safety device for use in wilderness trekking is dual functioning in a first and second mode of operation. In the first mode of operation, an alarm is sounded using a recorded or generated sound effect that is unpleasant to dangerous animals, particularly those encountered in the North American wilderness, such a mountain lions, black and brown bears, wolves and other predatory animals. In a second mode of operation, a GPS reading is taken to obtain the user's location and, in an emergency, a beacon signal with location data may be sent manually or automatically, for example by satellite or mobile data network, to a data service. The data service may forward the location and emergency information to emergency services or to a predetermined personal contact. The device will preferably be battery powered, waterproof, and shock resistant.

### CROSS-REFERENCE TO RELATED APPLICATIONS

This Application claims priority to U.S. Provisional Application No. 61/755,032, filed Jan. 22, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to electronic self-protection devices and in particular to an electronic self-protection device for wilderness trekking. Sportsmen who travel on foot through wilderness areas are often at risk from wild animals such as black and brown bears, mountain lions, wolves, and similar predators. A lightweight electronic device which can be caused to emit an alarm in a frequency range that is inaudible to humans, but audible and extremely unpleasant or painful to animals, and in particular predatory animals, would provide protection by causing such animals to leave the area. In a second mode of operation, the device would use a Global Positioning System satellite signal to establish the user's location and, in an emergency, a beacon signal with location data may be sent manually or automatically, for example by satellite or mobile data network, to a data service. The data service may then forward the location and emergency information to emergency services or to a predetermined personal contact. Such a device that can protect the user from wild animals, and notify emergency services or a personal contact in the event of any emergency, would be extremely useful to sportsmen in wilderness areas.

### SUMMARY OF THE INVENTION

Accordingly, the invention is directed to a safety device for use in wilderness trekking. The device is dual functioning and in the first mode of operation, an alarm is sounded using a recorded or generated sound effect that is unpleasant to dangerous animals, particularly those encountered in the North American wilderness, such a mountain lions, black and brown bears, wolves and other predatory animals. In a second mode of operation, a GPS reading is taken to obtain the user's location and, in an emergency, a beacon signal with location data may be sent manually or automatically, for example by satellite or mobile data network, to a data service. The data service may forward the location and emergency information to emergency services or to a predetermined personal contact. The device will preferably be battery powered, waterproof, and shock resistant.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawing is included to provide a further understanding of the invention and is incorporated into and constitutes a part of the specification. It illustrates one embodiment of the invention and, together with the description, serves to explain the principles of the invention.

FIG. 1 shows the first exemplary embodiment and displays the device 10, the speaker 11, the animal protection button 12, the emergency beacon button 13, the belt clip 14, the lanyard 15, the attachment rings 16, and the battery pack 17.

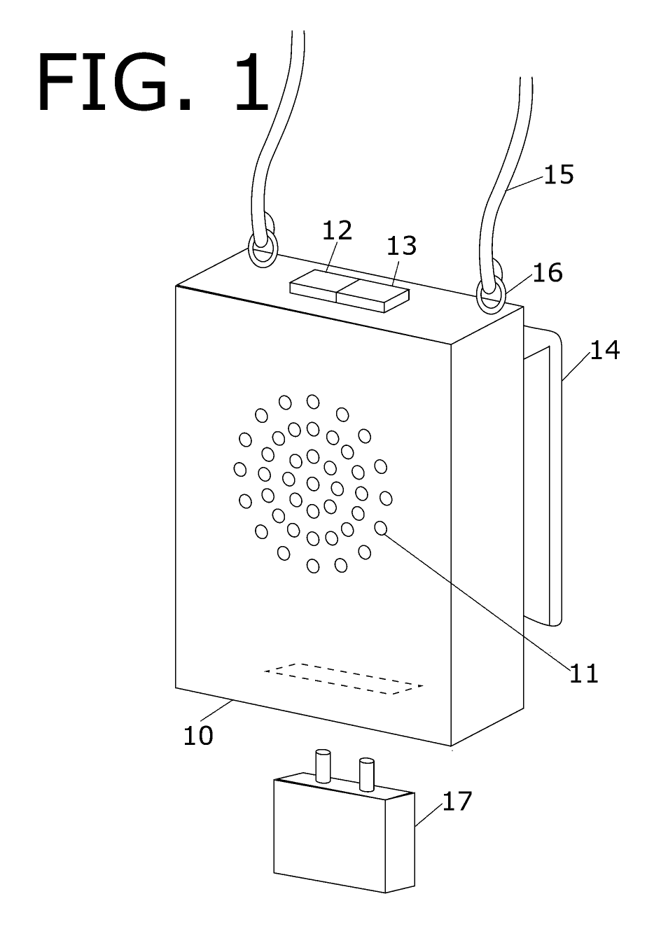

### DETAILED DESCRIPTION OF THE INVENTION

Referring now to the invention in more detail, the invention is directed to a safety device 10 for use in wilderness trekking. The device 10 is dual functioning and in the first mode of operation, pressing an animal protection button 12 preferably causes an alarm to be sounded from a speaker 11, using a recorded or generated sound effect that is unpleasant to dangerous animals, particularly those encountered in North American wilderness, such a mountain lions, black and brown bears, wolves, and other predatory animals. The alarm would preferably be audible for one mile. Pressing the animal protection button 12 a second time will deactivate the alarm. In a second mode of operation, a GPS reading is taken by the device 10 to obtain the user's location and, in an emergency, a beacon signal with location data may be sent manually with an emergency beacon button 13 or automatically, for example by satellite or mobile data network, to a data service. The data service may then forward the user's location and emergency information to emergency services or to a predetermined personal contact.

The animal protection button 12, the emergency beacon button 13, the belt clip 14, the battery pack 17, and the outer shell of the device 10 would preferably be composed of rigid, durable, high impact material such as plastic or steel. The lanyard 15 would preferably be composed of a flexible material with high tensile strength such as nylon. The attachment rings 16 would preferably be composed of rigid, durable, high impact material such as steel, aluminum, or brass.

The animal protection button 12 and emergency beacon button 13 would preferably operate using standard switches such as alcohol, contact or mercury switches. When in the automatic mode, the device 10 would be activated if the user falls down or experiences another shock, to be detected by an internal shock detection device, for example an accelerometer. If the device 10 is activated in this manner, the user may deactivate the device 10 by twice pressing the animal protection button 12 or the emergency beacon button 13. If the device 10 is not deactivated within a predetermined time period, for example fifteen seconds, in its automatic embodiment, the device 10 would preferably send its emergency beacon signal. De-activation may be accomplished by pressing the emergency beacon button 13 again, or by a separate control. The signal would continue at a predetermined interval for a predetermined beacon period without depleting the battery supply.

The device 10 would preferably be waterproof and shock resistant, and would preferably be capable of sending its emergency beacon signal continuously at a pre-determined interval for a predetermined beacon period, for example twenty-four hours, without completely discharging the batteries. The device 10 would preferably be three inches high, two inches wide and half of an inch deep. The device 10 would preferably be secured to the user's body or backpack using a belt clip 14 or a lanyard 15, and would be powered with a battery pack 17, for example containing four removable AA batteries. The battery pack 17 would preferably be inserted into the bottom of the device 10. Removing the battery pack 17 would preferably turn the device 10 off and reset it. The lanyard 15 would be attached to the device 10 with two attachment rings 16.

The device 10 would preferably consist of a speaker 11, a processing unit to control the included functions, a data storage device, audio data, an internal timer, a cyclical delay device, a Radio Frequency (RF) transmitter, a GPS-enabled receiving device, and an internal shock detection device. An on/off switch is also contemplated as part of the device 10.

The internal processing unit of the device 10 would preferably receive data from the animal alarm button 12, retrieve audio data from the data storage device, and transmit the audio data to the speaker 11. In the second function mode, the processing unit would receive data from the emergency beacon button 13 or the shock detection device, obtain location data from the GPS satellite system, and transmit a distress beacon at pre-determined intervals utilizing a cyclical delay device and internal timer for twenty four hours.

The internal shock detector preferably consists of a housing, a central electrical contact, a plurality of smaller electrical contacts, and a component such as a ball to complete the circuit. When the circuit completion component fails to complete the circuit in such a way that the circuit completion component is moved a significant distance from the central electrical contact, the internal shock detector will send a signal to the processing unit which will then begin the automatic transmission of the distress beacon.

Components listed above are preferable, but artisans will recognize that alternative components and processes could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A wilderness safety device comprising:
(a) a device shell;
(b) a battery;
(c) said battery being disposed within said device shell;
(d) a support means for supporting said device shell about the person of a human user;
(e) a first activation button;
(f) a second activation button;
(g) said first activation button and said second activation button being mounted to the exterior of said device shell;
(h) an electronic sound generating means for generating a sound that is unpleasant to wild animals;
(i) said electronic sound generating means for generating a sound that is unpleasant to wild animals being physically located within said device shell, powered by said battery, and in electronic communication with said first activation button;
(j) said first activation button being configured to activate said electronic sound generating means for generating a sound that is unpleasant to wild animals;
(k) a GPS-enabled receiving device;
(l) a location transmitting means for transmitting location data wirelessly;
(m) said GPS-enabled device and said location transmitting means for transmitting location data wirelessly being, being physically located within said device shell, powered by said battery, and in electronic communication with each other and with said second activation button;
(n) said second activation button being configured to activate an emergency broadcast method;
(o) said emergency broadcast method comprising obtaining a location reading from said GPS-enabled receiving device and broadcasting said location, reading using said location transmitting means for transmitting location data wirelessly.

2. The wilderness safety device of claim 1 wherein said support means for supporting said device shell about the person of a human user comprises a belt clip; said belt clip being affixed to the exterior of said device shell.

3. The wilderness safety device of claim 1 wherein said support means for supporting said device shell about the person of a human user comprises a lanyard; said lanyard being linked to the exterior of said device shell by a pair of rings.

4. The wilderness safety device of claim 1 further comprising a deactivation signaling means for selectively obtaining a de-activation signal from the user, and wherein said emergency broadcast method further comprises waiting a predetermined time period before broadcasting said location reading, and, in the event that said de-activation signal is received during said predetermined time period, not broadcasting said location reading.

5. The wilderness safety device of claim 4 wherein said support means for supporting said device shell about the person of a human user comprises a belt clip; said belt clip being affixed to the exterior of said device shell.

6. The wilderness safety device of claim 4 wherein said support means for supporting said device shell about the person of a human user comprises a lanyard; said lanyard being linked to the exterior of said device shell by a pair of rings.

7. The wilderness safety device of claim 4 wherein said emergency broadcast method further comprises repeating broadcasting said location reading at pre-determined intervals until reaching a pre-determined beacon period, receiving de-activation signal, or said battery is discharged.

8. The wilderness safety device of claim 7 wherein said support means for supporting said device shell about the person of a human user comprises a belt clip; said belt clip being affixed to the exterior of said device shell.

9. The wilderness safety device of claim 7 wherein said support means for supporting said device shell about the person of a human user comprises a lanyard; said lanyard being linked to the exterior of said device shell by a pair of rings.

10. The wilderness safety device of claim 1 further comprising a shock detection device, said shock detection device being physically located within said device shell, powered by said battery, and in electronic communication with said GPS-enabled receiving device and said location transmitting means for transmitting location data wirelessly; and further comprising a method of automatic operation comprising detecting a shock signal from said shock detection device and responsively activating said emergency broadcast method.

11. The wilderness safety device of claim 4 further comprising a shock detection device, said shock detection device being physically located within said device shell, powered by said battery, and in electronic communication with said GPS-enabled receiving device and said location transmitting means for transmitting location data wirelessly; and further comprising a method of automatic operation comprising detecting a shock signal from said shock detection device and responsively activating said emergency broadcast method.

12. The wilderness safety device of claim 7 further comprising a shock detection device, said shock detection device being physically located within said device shell, powered by said battery, and in electronic communication with said GPS-enabled receiving device and said location transmitting means for transmitting location data wirelessly; and further comprising a method of automatic operation comprising detecting a shock signal from said shock detection device and responsively activating said emergency broadcast method.

13. The wilderness safety device of claim 10 wherein said support means for supporting said device shell about the person of a human user comprises a belt clip; said belt clip being affixed to the exterior of said device shell.

14. The wilderness safety device of claim 10 wherein said support means for supporting said device shell about the person of a human user comprises a lanyard; said lanyard being linked to the exterior of said device shell by a pair of rings.

15. The wilderness safety device of claim 11 wherein said support means for supporting said device shell about the person of a human user comprises a belt clip; said belt clip being affixed to the exterior of said device shell.

16. The wilderness safety device of claim 11 wherein said support means for supporting said device shell about the person of a human user comprises a lanyard; said lanyard being linked to the exterior of said device shell by a pair of rings.

17. The wilderness safety device of claim 12 wherein said support means for supporting said device shell about the person of a human user comprises a belt clip; said belt clip being affixed to the exterior of said device shell.

18. The wilderness safety device of claim 12 wherein said support means for supporting said device shell about the person of a human user comprises a lanyard; said lanyard being linked to the exterior of said device shell by a pair of rings.
